(19) United States
(12) Patent Application Publication
(10) Pub. No.: US 2009/0228208 A1
(43) Pub. Date: Sep. 10, 2009

(54) Navigation Device and Navigation Method Using the Same

(75) Inventor: Shih-Chi Yang, Hsinchu Hsien (TW)

Correspondence Address: EDELL, SHAPIRO & FINNAN, LLC, 1901 RESEARCH BOULEVARD, SUITE 400, ROCKVILLE, MD, 20850, US

(73) Assignee: MSTAR SEMICONDUCTOR, INC., Hsinchu Hsien (TW)

(21) Appl. No.: 12/389,852

(22) Filed: Feb. 20, 2009

(30) Foreign Application Priority Data
Mar. 7, 2008 (TW) 97108181

(51) Int. Cl. G01C 21/36

(52) U.S. Cl. 701/211; 701/207

(57) ABSTRACT

A navigation device and a navigation method using the same are provided. The navigation device includes a storage unit, a positioning module, a first calculating unit and a display unit. The first calculating unit is coupled to the storage unit, and the display unit is coupled to the first calculating unit. The storage unit stores at least a set of theme information. The positioning module detects longitude and latitude information of a current location so as to generate geographic information. The first calculating unit generates an indication direction according to the geographic information, a reference direction, and the theme information without referencing map data. The display unit displays the indication direction.

### CROSS REFERENCE TO RELATED PATENT APPLICATION

This patent application is based on a Taiwan, R.O.C. patent application No. 97108181 filed on Mar. 7, 2008.

### FIELD OF THE INVENTION

The present invention relates to a navigation device, and more particularly, to a navigation device capable of generating an indication direction without referencing map data, an electronic device with navigation capabilities and an associated navigation method.

### BACKGROUND OF THE INVENTION

Navigation devices are becoming more and more prevalentt. Via built-in map data for route planning, a navigation device displays electronic maps and provides indication directions to enable a user to arrive at a desired destination. However, the navigation device is necessarily equipped with a costly high-level processor serving as a map engine for performing the aforesaid functions such as route planning and displaying electronic maps, thus resulting in high manufacturing costs for navigation devices. Also, in order to use a navigation device, a consumer also needs to purchase high priced electronic maps, which may again deter the consumer from making the purchase.

Further, current navigation devices are coded with many predetermined landmarks for assisting a user to quickly find a destination. Yet, during a short-distance trip, only a very small part of information related to the predetermined landmarks is likely used, such that the considerable amount of remaining information related to the predetermined landmarks tends to waste storage space while also lengthening time needed for a user to find a destination.

In view of the foregoing, it is an object of the invention to provide an economical electronic device with navigation functions facilitating a user to quickly reach a desired destination.

### SUMMARY OF THE INVENTION

Embodiments of the invention provide a navigation device capable of generating an indication direction without referencing map data, and a navigation method using the same. The navigation device and the navigation method, capable of generating an indication direction without having to reference to map data, have at least the advantages of: a) providing convenience by enabling a user to quickly and accurately move toward a destination; b) significantly lowering manufacturing costs and increasing market competitive strength by not necessarily providing a costly high-level processor serving as a map engine; and c) substantially promoting consumer purchase inclination by eliminating additional purchases of high priced electronic maps.

A navigation device according to an embodiment of the invention comprises a storage unit, a positioning module, a first calculating unit and a display unit. The first calculating unit is coupled to the storage unit, and the display unit is coupled to the first calculating unit. The storage unit stores at least one set of theme information. The positioning module detects longitude and latitude information of a current location of the navigation device so as to generate geographic information. The first calculating unit generates an indication direction according to the geographic information, a reference direction, and the theme information without referencing map data. The display unit displays the indication direction.

A navigation method, which is implemented in a navigation device, according to an embodiment of the invention comprises steps of providing at least one set of point of theme information, detecting longitude and latitude information of a current location of the navigation device so as to generate geographic information, generating an indication direction according to the geographic information, a reference direction, and the set of point of theme information without referencing map data, and displaying the indication direction.

Further, a navigation method according to an embodiment of the invention comprises steps of providing a navigation device, a destination and a predetermined location; displaying navigation information of the destination by the navigation device; determining whether the navigation device is approaching the destination; and generating an alert signal when the navigation is situated within a predetermined range from the predetermined location.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of a navigation device according to a first embodiment of the invention.

FIG. 2 is a schematic diagram according to a second embodiment of the invention.

FIG. 3 is a schematic diagram according to a third embodiment of the invention.

FIG. 4 is a schematic diagram according to a fourth embodiment of the invention.

FIG. 5 is a flowchart of a navigation method according to an embodiment of the invention.

FIG. 6 is a flowchart of another navigation method according to an embodiment of the invention.

### DETAILED DESCRIPTION OF THE PREFERRED EMBODIMENT

To overcome drawbacks of conventional navigation devices and high priced electronic maps, embodiments of the invention provide a navigation device capable of generating an indication direction without referencing map data. The navigation device at least comprises a storage unit, a first calculating unit and a display unit. The first calculating unit is coupled to the storage unit, and the display unit is coupled to the first calculating unit. The storage unit stores theme information associated with a theme. According to geographic information and the theme information without referencing map data, the first calculating unit generates an indication direction to be displayed on the display unit. Several exemplary embodiments are illustrated below.

### First Embodiment

According to a theme desired by a user, the invention regards a point of interest (POI) associated with a specific theme chosen by the user as a point of theme (POT). For instance, suppose the user wishes to visit the 2008 Summer Olympic Games in Beijing with the help of the navigation device, the 2008 Summer Olympic Games in Beijing is then a desired theme of the user. Alternatively, any theme parks, Japanese restaurants, etc., may be a subject of interest of the user. Thus, POIs associated with the 2008 Summer Olympic Games in Beijing, such as venues for the various games, may be selected as the POTs. The user may specify one or a plurality of POTs, and one from the plurality of POTs may be chosen as a POT of a destination to be travelled to.

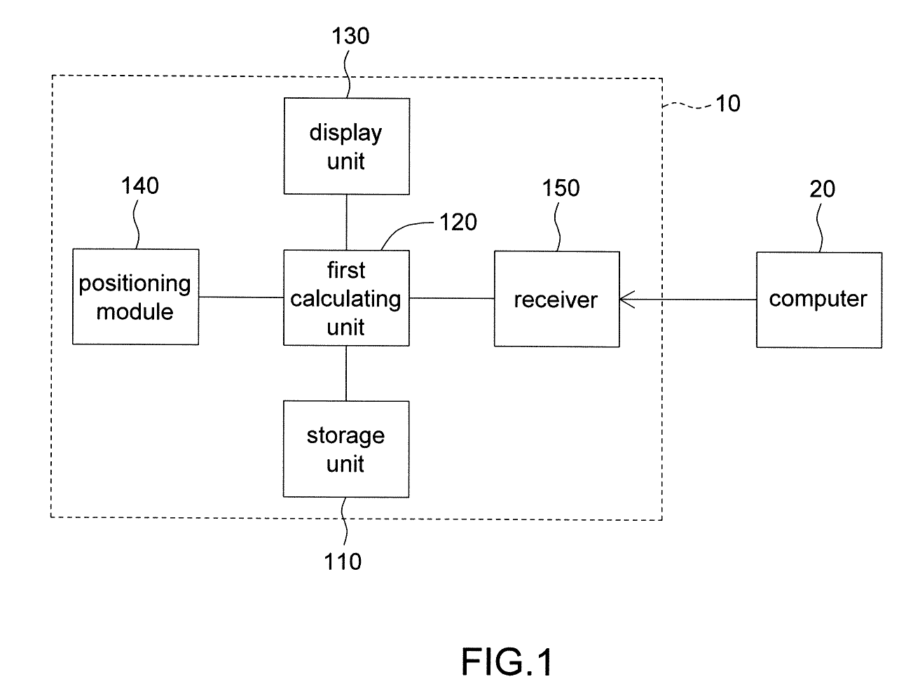

FIG. 1 shows a schematic diagram of a navigation device according to a first embodiment of the invention. The navigation device 10 comprises a storage unit 110, a first calculating unit 120, a display unit 130, a positioning module 140 and a receiver 150. The first calculating unit 120 is coupled to the storage unit 110, and the display unit 130 is coupled to the first calculating unit 120.

The navigating device 10 receives the theme information via the receiver 150 from a computer 20 by wired or wireless means. The theme information received by the receiver 150 is stored into the storage unit 110 via the first calculating unit 120. The receiver 150 may be a wired receiver including a Universal Serial Bus (USB) port and an RS232 port, or a wireless receiver including Bluetooth and infrared.

Preferably, the computer 20 generates the POT information by executing an application program. For example, the application program is map software or an online map such as Google MaP™. From the application program, the user is allowed to select at least one POI as at least one POT. When having selected the associated POI as the POT, POT information corresponding to the POT is loaded from the computer 20 to the navigation device 10. The POT information includes, e.g., longitude and latitude readings, POT name, transportation means passing by the POT, and introduction on the POT. Accordingly, a user is allowed to load self-specified POIs into the navigation device 10. The POIs are added or deleted based on a trip to be made by the user, and are associated with the theme of the trip. For example, POIs of the 2008 Summer Olympic Games in Beijing are stadiums including the Beijing National Stadium (the Bird's Nest) and the Beijing National Aquatics Center (the Water Cube).

The first calculating unit 120 is used for controlling detections of the positioning module 140 on longitude and latitude information of a current location of the navigation device 10. The first calculating unit 120 and the positioning module 140 may be concurrently realized using a Global Positioning System (GPS) chip. That is, the navigation device 10 according to the invention may be simply configured in a GPS chip, and is realized by providing the display unit 130 and the receiver 150. The storage unit 110 may be a built-in memory or an external memory of the GPS chip.

Since the storage unit 110 stores only destination POT information but not map data, the first calculating unit 120 directly generates indication directions of the current location and the destination according to the geographic information and the POT information without referencing map data. The map data signifies information such as street names and street correlations. Since the storage unit 110 is not loaded with map data, the first calculating unit 120 need not execute plotting of any electronic maps. Thus, compared to a conventional navigation device, the calculating unit 120 need not be a powerful processor.

Preferably, the first calculating unit further generates a linear distance value or an estimated traveling duration according to the geographic information and the POT information. According to longitude and latitude information of a current location and the destination, the calculating unit 120 calculates a linear distance from the current location to the destination. As mentioned previously, the first calculating unit 120 and the positioning module 140 may be realized using a GPS chip. For those skilled in the related art, a GPS chip is capable of calculating a current speed, and therefore an estimated traveling duration may be calculated upon obtaining the linear distance.

Further, the first calculating unit 120 displays the indication direction, the linear distance value and the estimated traveling duration on the display unit 130. According to the indication direction, the linear distance and the estimated traveling duration displayed on the display unit 130, the user can quickly and accurately move toward the destination.

Apart form the geographic information and the POT information, preferably the first calculating unit 120 generates an indication direction from the current location of the navigation device 10 to the destination according to a reference direction. The reference direction is, e.g., the north pointed out by an electronic compass or a GPS chip. The calculating unit may show solely the indication direction or both the indication direction and the reference direction.

Since, without referencing map data, the first calculating unit 120 is capable of generating an indication direction that enables the user to quickly and accurately move toward the destination, the navigation device 10 need not be provided with a costly high-level processor serving as a map engine for executing functions such as route planning and plotting electronic maps. Therefore, the navigation device 10 is rendered with lowered manufacturing costs as well as high market competitive strength. In addition, a consumer is not mandated to make additional purchases of high priced electronic maps, thus substantially promoting the likelihood of a consumer's purchase.

Besides generating an indication direction, with respect to the destination POT, the first calculating unit 120 also generates an alert signal for notifying the user when approaching the specified destination POT. The alert signal may be a predetermined symbol to be displayed on the display unit 130, or a predetermined sound or a predetermined melody to be played by the navigation device 10.

Alternatively, when the navigation device 10 approaches a predetermined POT, the first calculating unit 120 generates an alert signal for notifying the user that a predetermined POT associated with the theme is near the current location. A major difference between the predetermined POT and the foregoing destination POT is that, the destination POT is a location intended in advance by the user, while the predetermined POT is not the destination originally intended of traveling to. Since the predetermined POT and the destination POT may be associated with a same theme, the user may also become interested in the predetermined POT. Therefore, the first calculating unit 120 generates an alert signal for notifying the user that a predetermined POT associated with the theme is available nearby for visit if desired.

Further, the first calculating unit 120 generates a set of associated information by comparing two sets of POT information associated with the theme. For instance, the two sets of POT information corresponds to two game venues, respectively, taking the Olympic Summer Games as the theme, and the associated information is, e.g., traffic information between the two game venues. To be more precise, the first calculating unit 120 first compares whether same public transportation means, such as buses, travel to the two venues. In the event that same public transportation means is available between the two game venues, the first calculating unit 120 generates traffic information corresponding to the same transportation means for indicating ways for traveling back and forth between the two game venues.

### Second Embodiment

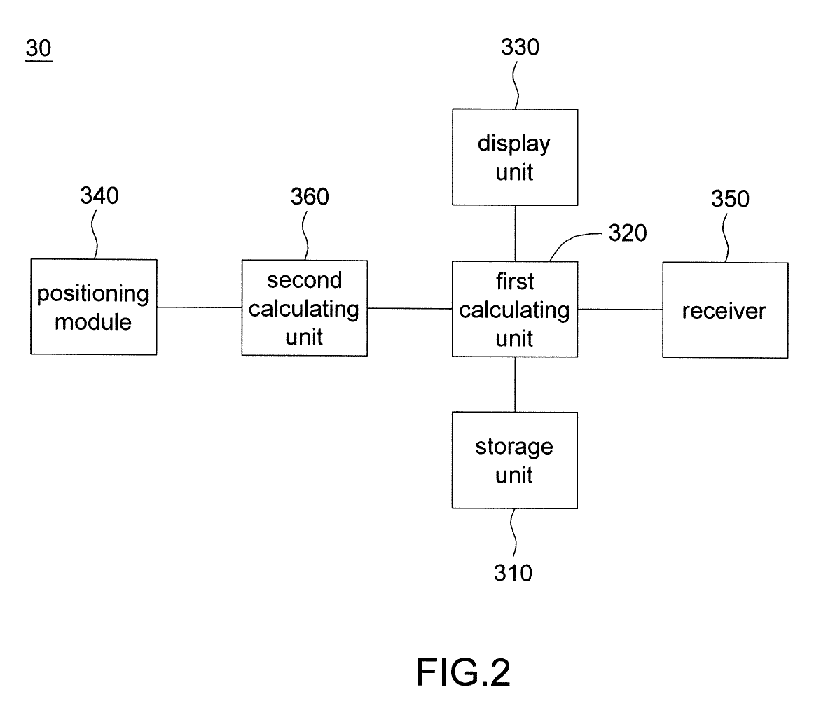

FIG. 2 shows a schematic diagram according to a second embodiment of the invention. A difference between the first and second embodiments is that, an electronic device 30 in the second embodiment further comprises a second calculating unit 360. The electronic device 30 may be a handheld electronic device such as a mobile phone, a PDA or a music player. For simplifying illustrations, certain modules in the portable electronic device are not depicted, e.g., a transceiver module in a mobile phone. The first calculating unit 320 serves as a processor for processing baseband signals in the electronic device 30. Associated principles and operations of remaining components including a storage unit 310, a display unit 330, a positioning module 340 and a receiver 350 are similar to those of the foregoing storage unit 110, the display unit 130, the positioning module 140 and the receiver 150, and shall not be unnecessarily further described.

The second calculating unit 360 is used for controlling detections of the positioning module 340 on longitude and latitude information of a current location of the navigation device 10 to generate geographic information. The positioning system 340 and the second calculating unit 360 are preferably realized using a GPS chip. When integrated with the GPS chip, the electronic device 30 is provided with positioning capabilities, and may be regarded as a navigation device by operating in coordination with a novel and simple navigation method disclosed by the present invention. The first calculating unit 320 need not perform controlling operations on the positioning module 340, and hence this embodiment further reduces operation load of the first calculating unit 320 compared to the first embodiment.

### Third Embodiment

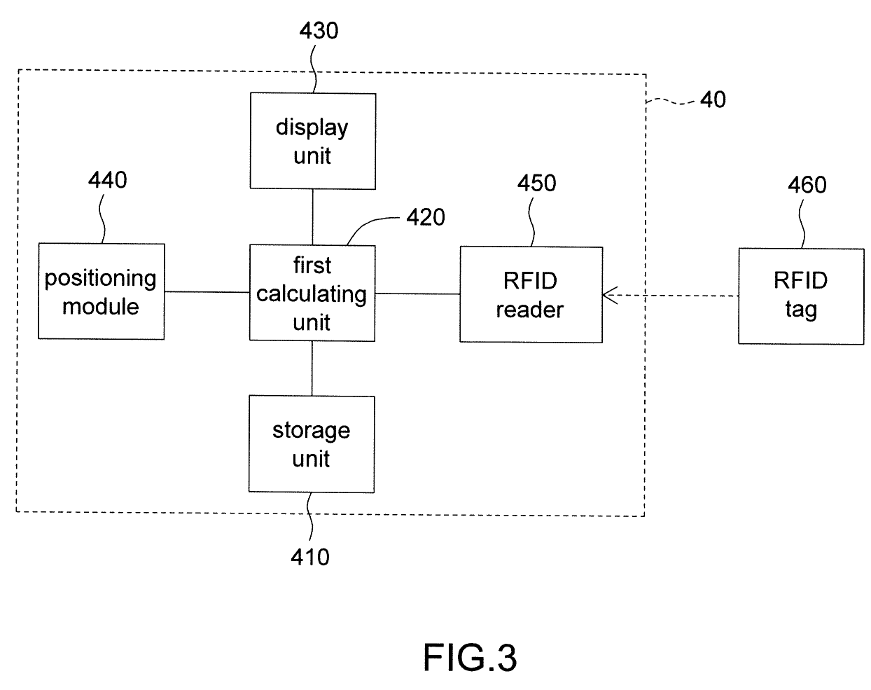

FIG. 3 shows a schematic diagram according to a third embodiment of the invention. A difference between the first and third embodiments is that, a navigation device 40 in the third embodiment comprises a radio frequency identification (RFID) reader 410 that replaces the receiver 150 in the first embodiment. Associated principles and operations of a storage unit 410, a first calculating unit 420, a display unit 430 and a positioning module 440 of the navigation device 40 are similar to those of the foregoing storage unit 110, the first calculating unit 120, the display unit 130 and the positioning module 140, and shall not be unnecessarily further described.

The navigation device 40 is capable of actively receiving POT information stored in an RFID tag 460 of the RFID reader 450 via RFID technology. The RFID tag 460 is preferably provided at locations that are potentially POTs, such as information counters or posters at entrances of theme parks. For example, the RFID tag 460 may be provided at various game venues of information stations of the 2008 Summer Olympic Games in Beijing. When situated near the RFID tag 460, the navigation device 40 may easily acquire POT information of the various game venues.

### Fourth Embodiment

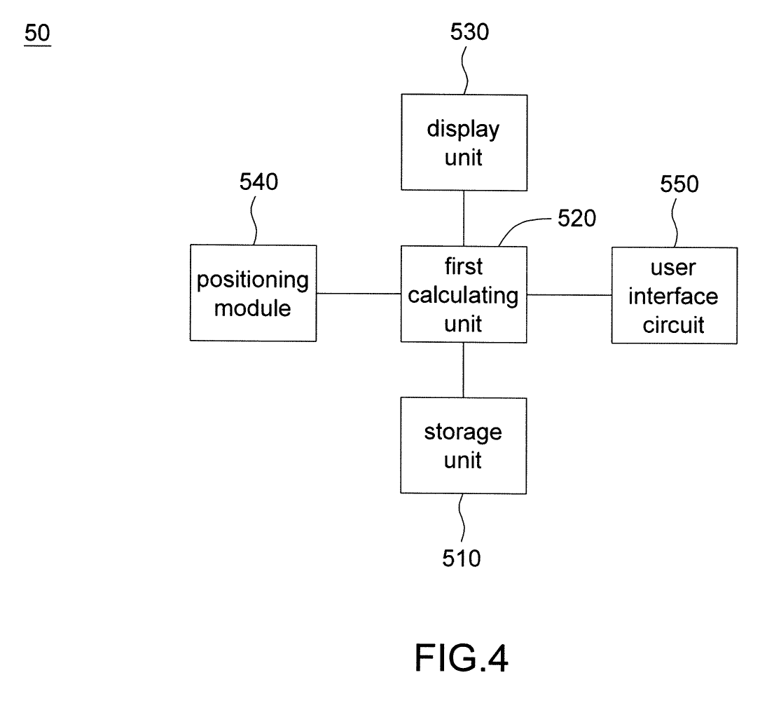

FIG. 4 shows a schematic diagram according to a fourth embodiment of the invention. A difference between the first and fourth embodiments is that, a navigation device 50 in the fourth embodiment comprises a user interface circuit 550 that replaces the receiver 150 in the first embodiment. Associated principles and operations of a storage unit 510, a first calculating unit 520, a display unit 530 and a positioning module 540 of the navigation device 50 are similar to those of the foregoing storage unit 110, the first calculating unit 120, the display unit 130 and the positioning module 140, and shall not be unnecessarily further described.

In the fourth embodiment, the first calculating unit 520 selectively records longitude and latitude information of a current location of the navigation device 50 into the storage unit 510. The first calculating unit 520 records longitude and latitude information of a current location of the navigation device 50 at every predetermined time interval such as ten minutes, or at every predetermined distance interval such as 300 meters. Alternatively, via the user interface circuit 550, the user may force the first calculating unit 520 to record longitude and latitude information of a current location of the navigation device 50, so as to provide basis for the user to set self-specified POIs. When the user considers a current location to be associated with a theme or becomes interested in a current location, the user may mark longitude and latitude information of a current location as a set of POT information via the user interface circuit 550, and store geographic information corresponding to the longitude and latitude information of a current location of the navigation device 50 detected by the positioning module 540 into the storage unit 510, such that the newly set POT may serve as POT information for future POTs to be specified by the user. Later when the user is situated at other locations, the navigation device 50 is facilitated to smoothly execute navigation using the previously marked and stored POT information for the user to travel to the same POT.

### Navigation Method

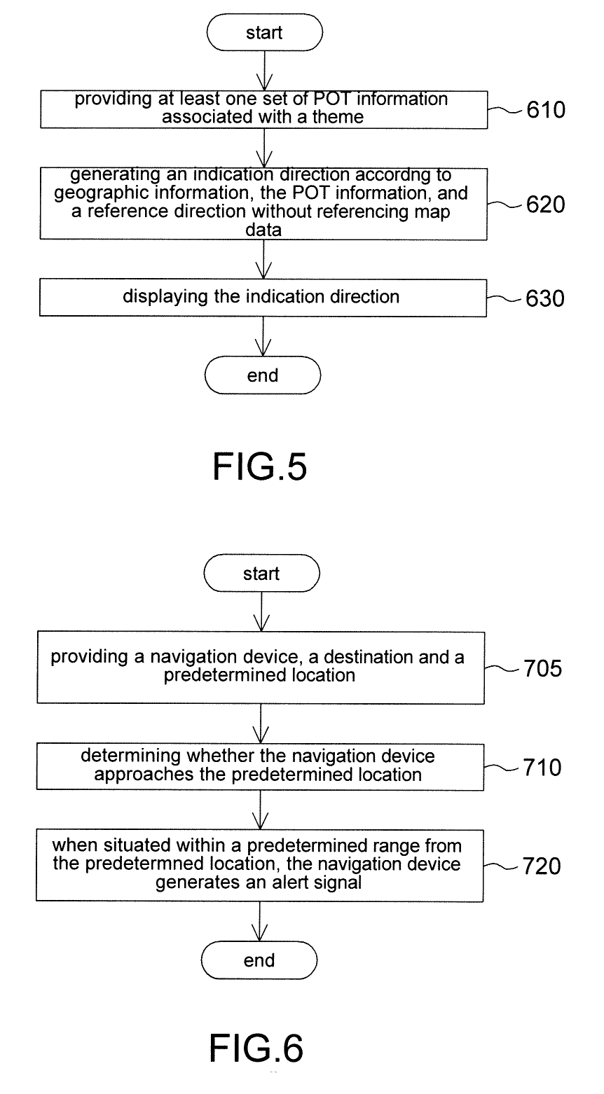

Embodiments of the invention further provide a navigation method. FIG. 5 shows a flowchart of one navigation method according to the invention. The navigation method may be implemented in the navigation device (or electronic device) described in the foregoing first to fourth embodiments. The navigation device 10 in the first embodiment shall be used as an example, and illustrations on steps of the navigation method according to the invention shall be given below. Step 610 shows providing at least one set of POT information associated with a theme. The POT information may be stored into the storage unit 110. In the next Step 620, the first calculating unit 120 generates an indication direction according to geographic information, the POT information, and a reference direction without referencing map data. In the final Step 630, the indication direction is displayed.

### Another Navigation Method

Embodiments of the invention provide another navigation method. FIG. 6 shows a flowchart of another navigation method according to the invention. The navigation method may be implemented in the navigation device (or electronic device) described in the foregoing first to fourth embodiments. The navigation device 10 in the first embodiment shall be used as an example, and illustrations on steps of the navigation method according to the invention shall be given below. Step 705 shows providing a navigation device 10, a destination and a predetermined location. The destination and the predetermined location may be associated with a same theme, e.g., the abovementioned Olympic Games venues, theme parks, Japanese restaurants. The navigation device 10 regards the destination but not the predetermined location as a target of navigation, and thus displays navigation information of the destination, based on which the user is facilitated to move toward the destination. In Step 710, it is determined whether the navigation device 10 approaches the predetermined location. During the time the user travels to the destination, the navigation device 10 constantly determines whether a current location is near the predetermined location according to longitude and latitude information of the current location. In the next Step 720, when situated within a predetermined range from the predetermined location, the navigation device 10 generates an alert signal. The predetermined range may be 100 meters from the predetermined location, for instance. The better the positioning capabilities of the positioning module 140 are, the smaller the predetermined range may be. In a preferred embodiment, the range may be user-specified.

According to the navigation device and the navigation method using the same as disclosed herein, an indication direction is generated without referencing map data, such that the aforesaid embodiments has at least the advantages of: a) providing convenience by enabling a user to quickly and accurately move toward a destination; b) significantly lowering manufacturing costs and increasing market competitive strength by not necessarily providing a costly high-level processor serving as a map engine; and c) substantially promoting consumer purchase inclination by eliminating additional purchases of high priced electronic maps.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A navigation device, comprising:
a storage unit, for storing at least one set of point of theme (POT) information;
a positioning module, for detecting longitude and latitude information of a current location so as to generate geographic information;
a first calculating unit, coupled to the storage unit, for generating an indication direction according to the geographic information, the POT information, and a reference direction without referencing map data; and
a display unit, coupled to the first calculating unit, for displaying the indication direction.

2. The navigation device as claimed in claim 1, wherein the display unit simultaneously displays the reference direction and the indication direction.

3. The navigation device as claimed in claim 1, wherein the map data includes street information of a current location of the navigation device.

4. The navigation device as claimed in claim 1, wherein the first calculating unit controls the positioning module so as to detect the set of geographic information.

5. The navigation device as claimed in claim 1, further comprising:
a second calculating unit, for controlling the positioning module so as to detect the set of geographic information.

6. The navigation device as claimed in claim 5, wherein the positioning module and the second calculating unit are realized using a Global Positioning System (GPS) chip.

7. The navigation device as claimed in claim 1, wherein the POT information comprises a POT name, and longitude and latitude information.

8. The navigation device as claimed in claim 1, further comprising:
a user interface circuit, for marking longitude and latitude information of a current location of the navigation device as the POT information.

9. The navigation device as claimed in claim 1, wherein the POT information is associated with a same theme.

10. A navigation method, comprising steps of:
providing at least one set of point of theme (POT) information;
detecting longitude and latitude information of a current location of a navigation device so as to generate geographic information;
generating an indication direction according to the geographic information, the set of POT information, and a reference direction without referencing map data; and
displaying the indication direction.

11. The navigation method as claimed in claim 10, wherein the reference direction and the indication direction are simultaneously displayed.

12. The navigation method as claimed in claim 10, being implemented in a navigation device, wherein the map data comprises street information of a current location of the navigation device.

13. The navigation method as claimed in claim 10, further comprising steps of:
generating a linear distance value according to the set of geographic information and the POT information; and
displaying the linear distance value.

14. The navigation method as claimed in claim 10, wherein the POT information includes a POT name, and longitude and latitude information.

15. The navigation method as claimed in claim 10, further comprising a step of:
generating an alert signal when situated near a predetermined POT.

16. The navigation method as claimed in claim 10, wherein the POT information is associated with a same theme.

17. A navigation method, comprising steps of:
providing a navigation device, a destination and a predetermined location, wherein the navigation device displays navigation information of the destination;
determining whether the navigation device approaches the predetermined location; and
generating an alert signal when the navigation device is situated within a predetermined range from the predetermined location.

18. The navigation method as claimed in claim 17, wherein the alert signal is displayed by a display unit of the navigation device.

19. The navigation method as claimed in claim 17, wherein the alert signal is played by an audio playing device of the navigation device.

20. The navigation method as claimed in claim 17, wherein the destination and the predetermined location are associated with a same theme.
